(19) United States
(12) Patent Application Publication
(10) Pub. No.: US 2004/0196454 A1
(43) Pub. Date: Oct. 7, 2004

(54) Optical system, detector and method for detecting peripheral surface defect of translucent disk

(76) Inventor: Takayuki Ishiguro, Tokyo (JP)

Correspondence Address: MATTINGLY, STANGER & MALUR, P.C., Suite 370, 1800 Diagonal Road, Alexandria, VA, 22314, US

(21) Appl. No.: 10/815,728

(22) Filed: Apr. 2, 2004

(30) Foreign Application Priority Data
Apr. 3, 2003 (JP) 2003-099867

(51) Int. Cl. G01N 21/88

(52) U.S. Cl. 356/239.1

(57) ABSTRACT

Defect in a edge portion of a disk is detected by irradiating a inspected region of an outer peripheral surface with light beam spot through an inside portion of the disk and receiving scattered light from the inspected region by means of a first light receiving system provided externally of the disk in a vicinity of the inspected region. Therefore, there is substantially no scattered light from alien attached externally of the disk.

### BACKGROUND OF THE INVENTION

1. Field of the Invention

The present invention relates to an optical system, a device and a method for detecting peripheral surface defect of a disk whch is translucent or transparent, i.e. transmission disk. In particular, the present invention relates to an optical system capable of efficiently detecting a peripheral surface defect of a glass disk such as crack or beak in an inner or outer peripheral edge portion of the disk with high precision without detecting extraneous substance or alien attached thereto.

2. Description of the Prior Art

The memory density of a magnetic disk used as an information recording medium for a computer, etc., is being increased more and more recently. With such tendency, the thickness of a magnetic layer and/or a protective film formed on a surface of the disk is being reduced. As shown in FIG. 7, a fabrication process of a magnetic disk having a glass disk as a substrate may include a lapping step (1) for polishing the glass substrate by a lapping device and a mirror polishing step (2) for polishing both surfaces of the glass substrate to surface roughness on the order of 1 nm. Thereafter, the glass substrate is washed (first washing step (3) and is inspected on a surface defect and a peripheral surface detect (first surface test step (4)). The glass substrate passed in the first surface test step is washed (second washing step (5)), and a metal under layer of chromium, copper or NiAl, etc., 50 to 2000 Å thick is formed on the glass disk by sputtering, etc. (metal under layer forming step (6)) and, then, a ferromagnetic thin film of, for example, cobalt alloy 100 to 1000 Å thick is formed on the under layer by sputtering, etc. (magnetic layer forming step (7)). Thereafter, a protective film such as a carbon, carbon hydride or carbon nitride film 10 to 150 Å thick is formed on the ferromagnetic layer by sputtering, etc. (protective film forming step (8)). Thereafter, in order to remove small protrusions resulting from these film forming steps and to clean a surface of the glass disk, a tape cleaning, etc., of the surface of the magnetic disk is performed by using a polisher (varnishing and wiping step (9)) and, finally, a surface test is performed (second surface test step (10)).

As mentioned above, the recent magnetic disk, which is one of the information recording media, is formed with the glass substrate and the magnetic film formed thereon. Although the surface of the glass disk is smoothened by polishing, edges of an inner and/or outer periphery of the disk may be broken off or cracked during the polishing step or during a handling of the disk, resulting in degradation of disk quality. In the first surface test step (4), the inspection on crack or break is performed and, when the size of crack is small enough, the disk is polished again. When the crack size is large, the disk is decided as unacceptable. The size of crack is determined by the defect tester.

The outer peripheral edge portion of the glass disk and crack defect thereof will be described with reference to FIG. 6(a) and FIG. 6(b).

FIG. 6(a) is a plan view of a glass disk 1 having any outer diameter. The glass disk 1 has a center hole HO having a predetermined diameter. FIG. 6(b) is a cross sectional view of an outer peripheral portion of the disk 1 having an upper surface 1a, a lower surface 1b and an outer peripheral side surface 1c. Both edges of the outer peripheral portions of the disk 1 are chamfered as shown by an up-side chamfered portion ChU and a down-side chamfered portion ChD. An outer peripheral edge portion E (an outer peripheral surface) is defined in a region between the outer peripheral side surface 1c and a position remote from the peripheral side surface 1c by a distance d. Crack or break in the outer peripheral edge portion E is shown by a peripheral surface defect K. The distance d depends upon the size of the disk 1 and, when the disk is a 2.5 inch disk, the distance d is 0.2 mm.

Recently, the glass substrate is mainly used for the disk 1 and the thickness thereof becomes smaller and small. With the request of higher recording density, the distance d is also reduced. Therefore, the inspection of glass disk by means of the conventional peripheral surface defect tester is becoming difficult.

Japanese Patent No. 3141974 (JPH7-190950A) assigned to the assignee of this application discloses a conventional outer peripheral edge defect inspecting method. The method disclosed therein utilizes a light source for directing light to the up-side portion of the outer peripheral portion at about 30° with respect to a normal line, a first light receiving system for receiving light scattered by crack, etc., in the chamfered portion and a second light receiving system for receiving scattered light from the outer peripheral side surface of the disk.

JPS64-57154A discloses a defect detector for detecting defect in a surface of a disk by irradiating the surface of the disk with light beam externally of the disk. The light beam entered into an inside of the disk is totally reflected within the disk and defect, which is not a surface defect, on the disk is detected by receiving scattered light from an outer peripheral side surface of the disk.

Recently, a high speed disk rotated at high speed over 5400 rpm and having increased recording density is used as a hard disk drive (HDD). Therefore, in order to reduce the weight of the disk, the thickness of the glass disk is reduced and, in order to increase the recording density, a track portion of the disk is expanded to the very limits of an inner and outer peripheral portions. Consequently, peripheral surface defect in the inner or outer peripheral portion of the disk influences the quality of disk even if the defect is small. If a disk having surface defect is incorporated in the HDD, probability of malfunction of the HDD becomes high.

In a case where crack defect in an outer peripheral edge of a disk is detected by the technology disclosed in JPH7-190950, alien attached to the disk may be also detected, causing product yield to be degraded. Therefore, the technology disclosed in JPH7-190590 can not be applied to a production of high density HDD at present. That is, a highly precise detection of crack or break defect of an outer peripheral edge portion of a disk without detecting aliens attached thereto is requested.

### SUMMARY OF THE INVENTION

An object of the present invention is to provide a peripheral surface defect detection optical system, a peripheral surface defect detector and a peripheral surface defect detection method, for efficiently detecting crack or break in an outer peripheral edge portion of a transmission disk by substantially excluding detection of aliens attached to the disk.

According to the present invention, each of the peripheral surface defect detection optical system and the peripheral surface defect detector, for efficiently detecting crack or break in an outer peripheral edge portion of a transmission disk is featured by comprising a light illuminating system for directing light beam to a peripheral surface of the transmission disk at a predetermined incident angle to irradiate a inspected region of a edge portion with light propagating within the disk and a first light receiving system provided externally of the disk and in the vicinity of the inspected region for receiving scattered light from the inspected region.

The peripheral surface defect detection method of the present invention is featured by that a peripheral surface defect of the disk is detected by receiving scattered light from the inspected region by the above mentioned first light receiving system while rotating the disk.

As mentioned above, the inspected region of the peripheral surface is irradiated with light beam propagating within the disk and light from the inspected region, which may be scattered by defect, is received by the first light receiving system provided externally of the disk and in the vicinity of the inspected region. Therefore, the first light receiving system receives substantially no scattered light from aliens attached to the surfaces of the disk.

As a result, it is possible to highly precisely detect crack defect or break defect in the inner and outer peripheral edge portions of the glass disk without detecting aliens attached to the surfaces of the disk.

Since the disk has the center hole, the peripheral surfaces of the disk remote from the center hole are referred to as an outer peripheral surfaces and peripheral surfaces in the vicinity of the center hole are referred to as an inner peripheral surfaces of the disk in the following description of the invention.

### BRIEF DESCRIPTION OF THE DRAWINGS

FIG. 1 is a block diagram showing an embodiment of a glass disk tester including a detection optical system according to the present invention;

FIG. 2(a) illustrates a laser beam incident on a glass disk;

FIG. 2(b) illustrates a relation between light beam incident to an inside of the glass disk and a inspected region of the glass disk;

FIG. 3(a) shows a detection system for detecting defect in a chamfered portion of the disk;

FIG. 3(b) shows a detection system for detecting defect in an outer peripheral side surface of the disk;

FIG. 3(c) shows a relation between scattered light inside of the disk and the detection system for detecting defect in the outer peripheral side surface;

FIG. 4(a) is a plan view of a disk for explaining a principle of defect detection by providing a predetermined offset OF from a portion of the disk from which reflected light is emitted;

FIG. 4(b) is a partial cross section of the disk, showing an outer peripheral portion thereof;

FIG. 5 is another embodiment of the present invention, for detecting defect in an inner peripheral surface;

FIG. 6(a) is a plan view and a cross sectional view of a disk;

FIG. 6(b) shows an outer peripheral edge portion E of the glass disk and defect therein; and

FIG. 7 shows an example of a manufacturing process of a magnetic disk utilizing a glass substrate.

### DETAILED DESCRIPTION OF THE PREFERRED EMBODIMENTS

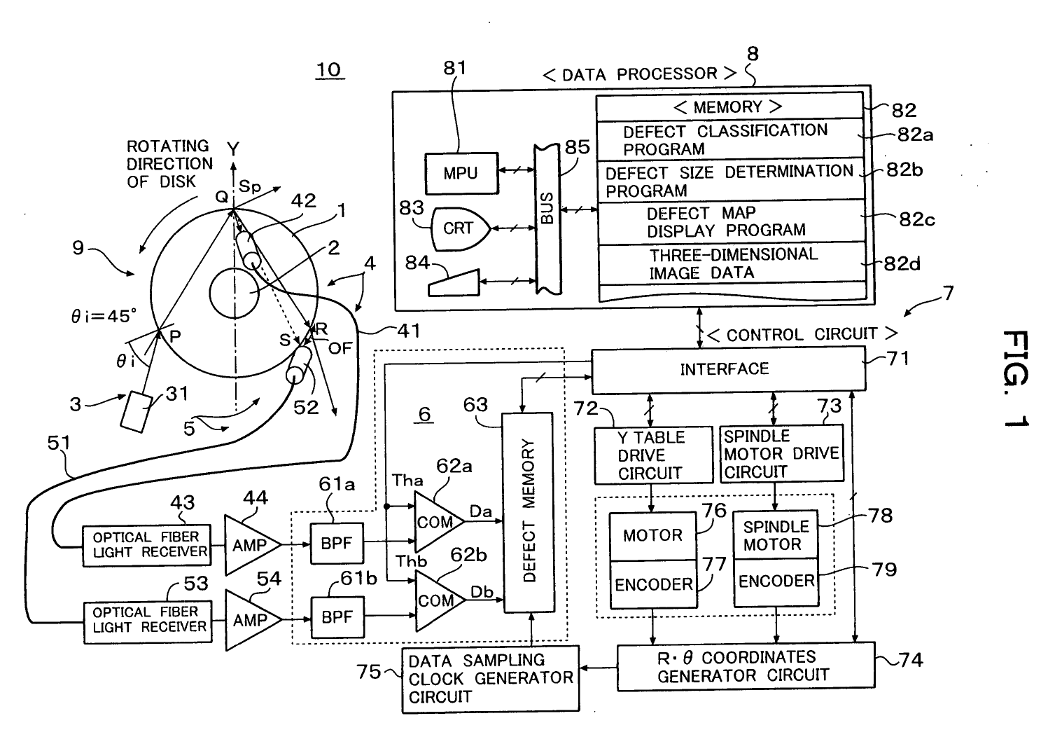

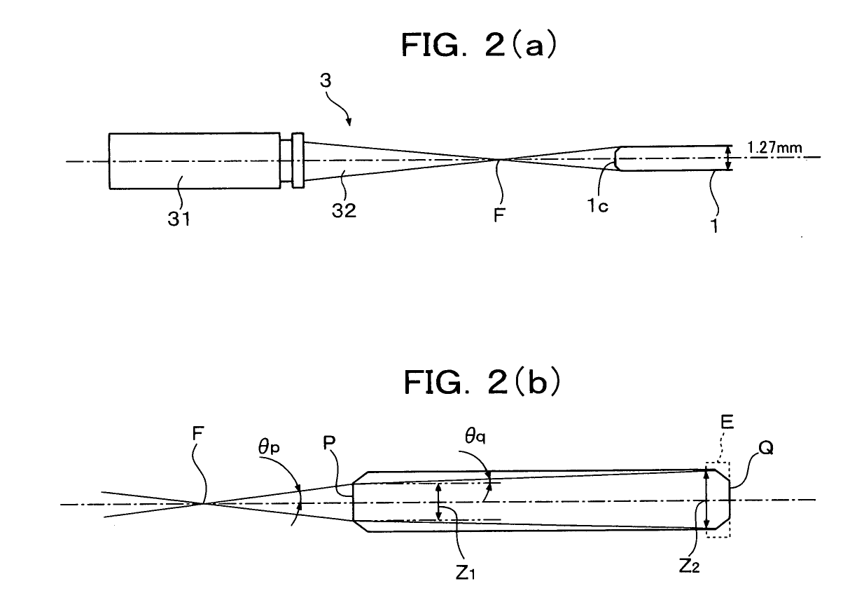

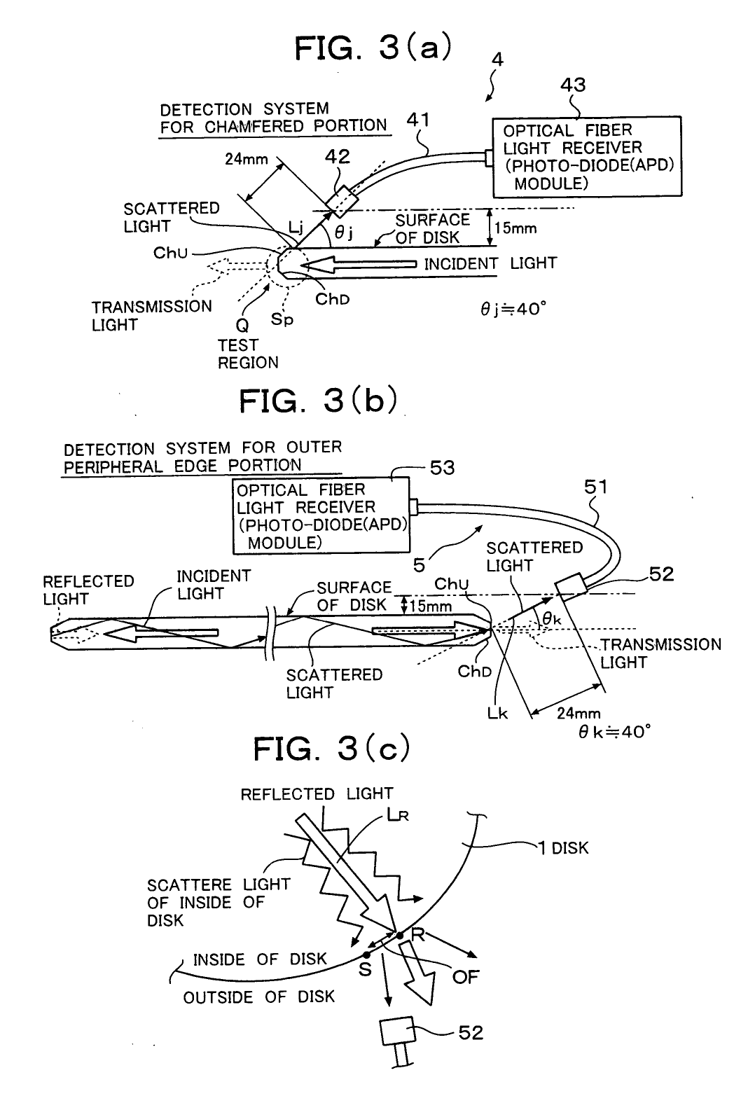

In FIG. 1, a defect detection optical system 9 of a defect tester 10 comprises a spindle 2 for rotating a glass disk 1 mounted thereon, an optical system 3 for directing a laser beam from a laser light source 31 to a position P (see FIG. 1 and FIG. 2(b)) in a side surface of the disk 1 at an incident angle θi≈45° to form a laser spot Sp at the position P to thereby irradiate a inspected region Q (light receiving outer peripheral surface, see FIG. 3(a)) of the outer peripheral surface through an inside of the disk 1, a first light receiving system 4 (see FIG. 3(a)) for receiving scattered light from the inspected region Q and a second light receiving system 5 (see FIG. 3(b)) for receiving scattered light, which propagates within the disk 1, from the inspected region Q.

As shown in FIG. 3(a), the first light receiving system 4 is provided externally of the disk 1. The first light receiving system 4 includes an optical fiber 41, a light receiving member 42 connected to one end of the optical fiber 41 to form a light receiving plane for receiving light scattered by defect in the inspected region of the disk 1 and an optical fiber light receiver (avalanche photo-diode (APD) module) 43 connected to the other end of the optical fiber 41. The light receiving member 42 is arranged such that a line normal to the light receiving plane thereof makes an angle θj (FIG. 3(a)) with respect to an upper surface of the disk 1, that is, the light receiving plane becomes substantially in parallel to a down side chamfered portion ChD and the light receiving plane of the light receiving member 42 is opposite to the down side chamfered portion ChD in the inspected region Q of the outer peripheral portion of the disk 1.

With such arrangement of the light receiving member 42, light scattered by an up side chamfered portion ChU and the down side chamfered portion ChD can be easily received by the light receiving member 42. However, scattered light from the outer peripheral side surface, which is right angle with respect to a horizontal direction, is hardly received by the light receiving member. Therefore, the first light receiving system 4 becomes a detection system for detecting crack defect of the chamfered portions of the inspected region.

On the other hand, as shown in FIG. 3(b), the second light receiving system 5 includes an optical fiber 51, a light receiving member 52 having a light receiving plane and connected to one end of the optical fiber 51, for receiving scattered light scattered by defect in the inspected region of the disk 1 and an optical fiber light receiver (avalanche photo-diode (APD) module) 53 connected to the other end of the optical fiber 51. As shown in FIG. 3(c), the light receiving member 52 is provided obliquely with respect to a detection position S of the outer peripheral side surface. The detecting position is offset from an emitting position R from which the regularly reflected light of the laser spot Sp propagating internally of the disk 1 from the inspected region Q is emitted externally of the disk 1. An amount OF of the offset may be about 10 mm in a case when the disk 1 is, for example, a 3.3 inch disk. In order to make the light receiving plane of the light receiving member 52 of the second light receiving system 5 substantially vertical to the down side chamfered portion ChD, the second light receiving member 52 is set at an angle θk (FIG. 3(b)) with respect to an upper surface of the disk 1.

With such arrangement of the light receiving member 52, scattered light from the outer peripheral side surface, which is perpendicular to the horizontal direction, can be easily received by the light receiving member 52. However, scattered lights from the chamfered portions ChU and ChD, which are tilted from the horizontal direction by predetermined amounts, are hardly received by the light receiving member 52. Therefore, the second light receiving system 5 becomes a detection system for detecting crack defect in the outer peripheral side face.

Incidentally, the emitting point R from which the regularly reflected light of the laser spot Sp is emitted is symmetrical to the incident position P in the side surface of the disk 1 about a Y axis (diameter line of the disk 1) passing through the inspected region Q.

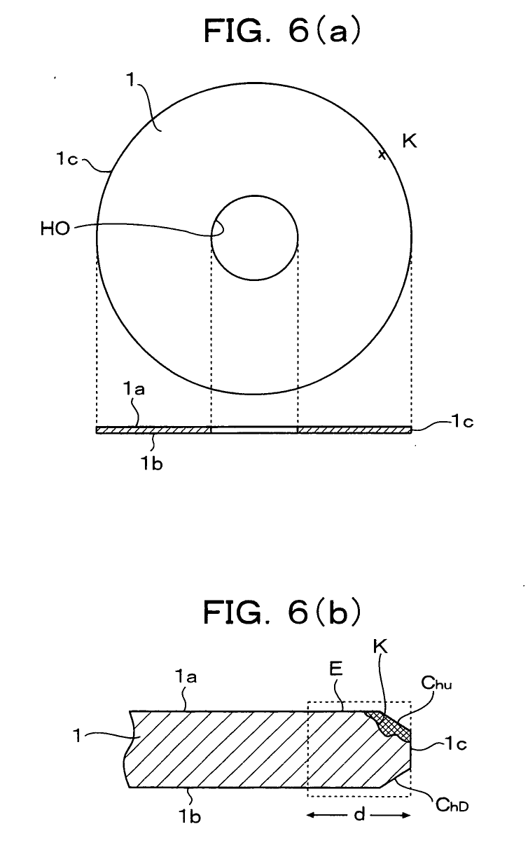

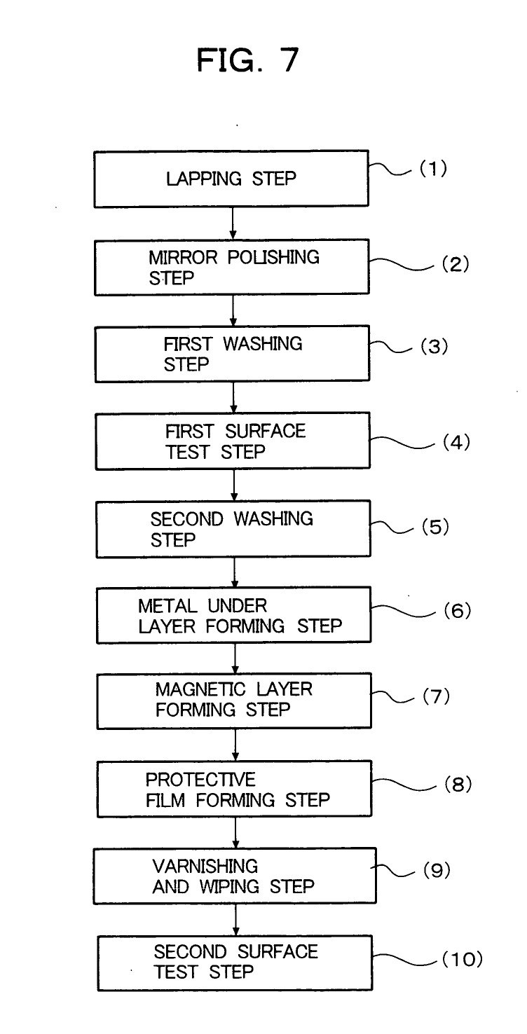

The defect detection optical system 9 illuminates the laser spot Sp from the illumination system 3 to the outer peripheral edge portion E (see FIG. 6) of the rotating disk 1 through the inside of the disk 1. The irradiating position of the laser spot Sp defines the above mentioned inspected region Q. As shown in FIG. 3, scattered light Lj from the peripheral surface defect is received by the first light receiving system 4 and scattered light Lk in the vicinity of the regularly reflected light propagating internally of the disk is received by the second light receiving system 5.

The light receiving member 42 of the first light receiving system 4 detects defects in the chamfered portions ChU and ChD in the inspected region Q. On the other hand, the light receiving member 52 of the second light receiving system 5 detects defects in the outer peripheral side surface. By separating the light receiving system for detecting defect in the chamfered portions of the disk 1 from the light receiving system for detecting defect in the outer peripheral side surface of the disk 1 as mentioned above, it is possible to highly precisely detect small crack and/or break. Further, since scattered light in the inspected region Q is obtained by irradiating the disk surfaces with the laser light propagating within the disk 1 and no alien attached to the interior of the disk 1, alien can not be detected. Even when alien is attached to the outer peripheral surface in which crack and/or break exist, scattered light from the aliens is totally reflected by the peripheral or edge surface of the disk as a boundary plane and does not reach the light receiving member 42 of the optical fiber 41 or the light receiving member 52 of the optical fiber 51. Therefore, defect, which can be detected by the detection optical system, is substantially limited to crack and/or break defect in the outer peripheral edge portion.

FIG. 2(a) and FIG. 2(b) illustrate the illumination system 3 for illuminating light to the outer peripheral portion of the disk 1 through the inside of the disk 1.

In FIG. 2(a), a laser light source 31 of the optical system 3 includes a condenser lens having focal point F. Laser beam 32 is focused at the point F and is incident on the incident position P of the outer peripheral side surface 1c of the disk 1 as the laser spot Sp. In this embodiment, the disk 1 is a 3.3 inch disk having thickness t=1.27 mm.

A cross section of the laser spot Sp at the incident position P of the outer peripheral side surface 1c is ellipsoidal having major diameter of about 1.0 mm, which corresponds to height Z1 (see FIG. 2(b)) of the outer peripheral side surface 1c between the chamfered portions ChU and ChD and is incident obliquely to the side surface 1c at an angle θi=45°, as shown in FIG. 1.

As shown in FIG. 2(b), the laser beam 32 is condensed at the focal point F, then expanded by an angle θp in each side with respect to a line parallel to the disk surface and incident on the outer peripheral side surface 1c as the spot Sp having height Z1. Thereafter, the laser beam is refracted and enters into the inside of the disk. In the disk, the beam is refracted by an angle θq in each side and reaches the inspected region Q (edge portoin E) as a spot having height Z2 and covering the chamfered portions ChU and ChD and the outer peripheral side surface 1c. The angle θp and the focal point F are determined to realize such optical characteristics.

With such optical characteristics, scattered light to be detected can be substantially limited to those from crack and/or break defect in the outer peripheral edge portion without influence of scattered light due to aliens attached to the surfaces of the disk 1.

By directing the incident light to the disk at the incident angle θp, which is smaller than the total reflection angle, as mentioned above, ratio of light passing through an upper or lower surface of the disk 1 can be made small. As a result, scattered light from aliens attached to the upper and/or lower surface of the disk 1 is reduced and possibility of the detection of alien is reduced.

Incidentally, it is possible that the incident light angle θp of the laser beam 32 to the outer peripheral side surface 1c may be larger than the total reflection angle with respect to the upper or lower surface of the disk 1. This is because the light directed to the inside of the disk 1 is totally reflected between the upper and lower surfaces of the disk 1 and there is substantially no light leaking externally of the disk 1.

As shown in FIG. 1, the light entered into the inside of the disk is refracted depending upon the refraction index n of glass, which is 1.536, and irradiates a position, which is coincident with the cross point between the refracted light and the Y axis in the inspected region Q from the inside of the disk.

FIG. 3(a) and FIG. 3(b) show the first and second light receiving systems 4 and 5, respectively.

As shown in FIG. 3(a), the light receiving member 42 connected to the optical fiber 41 of the first light receiving system 4 is set at angle θj, which is about 40° with respect to the surface of the disk 1, and is arranged in a location about 15 mm high from the surface of the disk 1 and remote from the outer peripheral edge portion of the disk by about 24 mm, so that the light receiving member 42 of the optical fiber 41 becomes substantially in parallel to the down side chamfered portion ChD in the inspected region Q of the outer peripheral edge portion, that is, the light receiving plane of light receiving member 42 or the light receiving plane of the optical fiber 41 is opposing to a chamfered surface of the chamfered portion ChD.

The rear end portion of the optical fiber 41 is connected to the avalanche photo-diode (APD) housed in the APD light receiving module 43.

Incidentally, an arrow in FIG. 3(a) shows the light incident on the laser spot Sp in the inspected region Q and a dotted arrow shows a direct light in the laser spot Sp transmitted externally through the inspected region Q.

Similarly, the second light receiving system 5 includes the optical fiber 51 and the light receiving member 52 connected to one end of the optical fiber 51 as shown in FIG. 3(b) and FIG. 3(c). The light receiving member 52 of the second light receiving system 5 is arranged in the detecting position S (light receiving position). The detecting position S is offset from the emitting position R, to which the regularly reflected light (internally propagating reflected light) from the inspected region (light receiving plane) Q within the disk 1 is incident, by the amount OF. In more detail, the light receiving member 52 is set at an angle Ok, which is about 40° with respect to the surface of the disk 1 and the detecting position S is about 15 mm high from the surface of the disk 1 and remote from the outer peripheral edge portion of the disk by about 24 mm, so that the light receiving member 52 of the optical fiber 51 becomes substantially vertical to the chamfered portion ChD in the inspected region Q of the outer peripheral edge portion. The other end of the optical fiber 51 is connected to the avalanche photo-diode (APD) housed in the APD light receiving module 53.

Incidentally, the angles θj and θk may be any provided that the scattered lights from the chamfered portions and the outer peripheral side surface can be received, respectively. However, it is preferable that the angles are selected such that substantially all of the scattered light can be received while transmitted lights or regularly reflected lights are excluded. The angles are usually within a range from about 20° to about 60° with respect to one of the surfaces of the disk 1.

Besides, light propagating toward the inside of the disk 1 in the inspected region Q of the outer peripheral edge portion is totally reflected within the disk and propagates along regularly reflected light LR while being scattered, as shown in FIG. 3(c). Therefore, in order to catch the scattered light, the previously mentioned offset OF is necessary. Further, scattered light in the inspected region Q becomes inner scattered light without leaking externally of the disk 1 and reaches the detecting position S after goes around while repeatedly reflected between the outer peripheral surface and the inner peripheral surface within the disk.

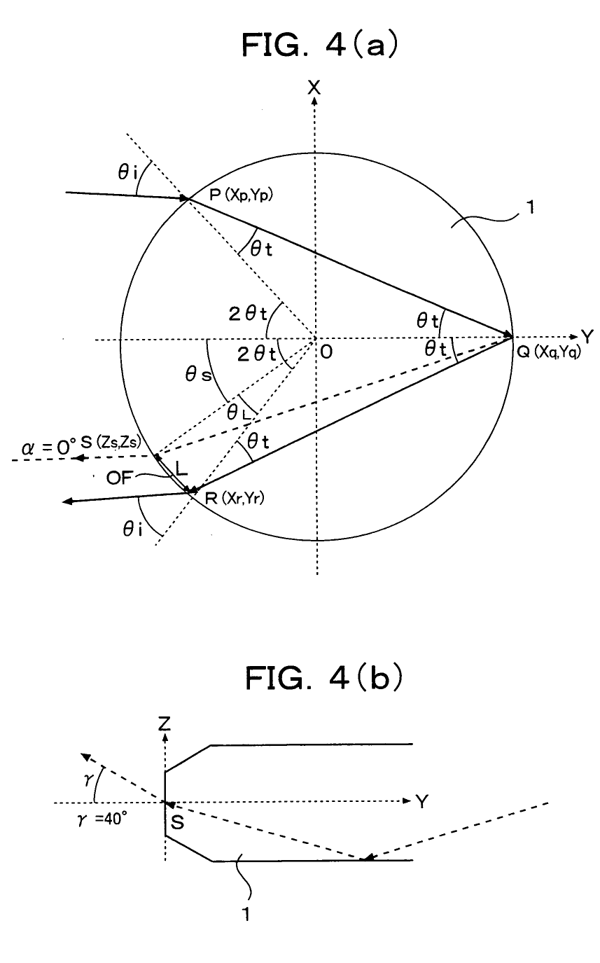

FIG. 4(a) is a plan view of the disk and FIG. 4(b) shows an outer peripheral edge portion thereof, for explaining the principle of the defect detection using the predetermined offset OF given to the emitting position R of the regularly reflected light.

It is assumed that radius r of the 3.3 inch disk 1 is 42 mm and refraction index n of the glass is 1.536. Further, the incident angle θi is 45° in FIG. 4(a). In FIG. 4(b), the emitting angle γ from the detecting position S is 40° (=θj) and an angle α of the emitting light in a horizontal plane is 0° (see FIG. 4(a). Further, the offset OF from the emitting position R of the regularly reflected light is 10 mm and X and Y axes are determined by the center of the disk 1 as an original point O.

Thus, coordinates (Xq, Yq) of the inspected region Q become (0 (mm), 42 (mm)) and coordinates (Xp, Yp) of the incident position P become (34.3286 (mm), −24.1981 (mm)). Coordinates (Xr, Yr) of the regularly reflected light emitting position R become (−34.3286 (mm), −24.1981 (mm)), which is symmetrical to the incident position P about the Y axis. As a result, coordinates (Xs, Ys) of the detection position S become (−27.6351 (mm), −31.6275 (mm)) since Xs=−r sin θs and Ys=−r cos θs, where θL=2 arcsin((L/2)/r)=13.67428°, θs=2θt−θL=41.14588° and L=OF=10 mm.

The angle at the center of the arc P-S is 2θs, θL is a difference between a half of the angle at the center of the arc P-R and the angle θs, θt=arcsin(Yn sin θi)=27.41008° and n=1.536 (see FIG. 4(a) and FIG. 4(b)).

When coordinates Q′ of a position in the vicinity of the outer peripheral side surface in the inspected region Q is traced along a light propagating from the point S to the point P under an assumption of angle α=0° and angle γ=40°, the coordinates Q′ of the reflected light obtained at the point S become (−0.89097 (mm), 41.99055 (mm))

The coordinates Q′ is deviated from the coordinates Q (0 (mm), 42 (mm)) by about 0.9 mm in the X direction and corresponds to the position at which scattered light is generated.

Therefore, it is possible to substantially catch scattered light in the outer peripheral edge portion in the inspected region Q. When the position in the vicinity of the point Q is deviated further from the point Q, the position is deviated from the scattered light receiving point. On the other hand, when the point is closer to the inspected region Q, it receives the regularly reflected light and it becomes impossible to detect defect in the outer peripheral side surface in the inspected region Q.

Returning to FIG. 1, detection signals from the APD modules 43 and 53 are amplified by respective amplifiers (AMPs) 44 and 54 and output signals of the amplifiers are inputted to a defect detection circuit 6. The defect detection circuit 6 includes band-pass filters (BPFs) 61a and 61b respectively connected to the outputs of the amplifiers 44 and 54, comparators (COMs) 62a and 62b respectively connected to outputs of the band-pass filters 61a and 61b and a defect memory 63. The comparators 62a and 62b have threshold values Tha and Thb, respectively, and output detection signals Da and Db when output signals of the BPFs 61a and 61b exceed the respective threshold values. Incidentally, the threshold values are provided in order to remove noise components of the detection signals of the APD modules 43 and 53 and are set by a control circuit 7. The detection signals Da and Db are bit data and are sampled according to sampling clock supplied from a data sampling clock generator circuit 75 and stored in the defect memory 63.

The defect detection circuit 6 operates to detect defects in not only a peripheral surface of the disk 1 but also the surfaces thereof. In this embodiment, the defect in the peripheral surface is detected by utilizing the same detection circuit 6.

The control circuit 7 includes an interface 71, a Y table drive circuit 72, a spindle motor drive circuit 73, a R·θ coordinates generator circuit 74 and the data sampling clock generator circuit 75. The control circuit 7 further includes a motor 76, an encoder 77 provided in the motor 76, a spindle motor 78 and an encoder 79 provided in the spindle motor 78. The threshold values Tha and Thb are sent to the control circuit 7 as data from a data processor 8.

The Y table drive circuit 72 of the control circuit 7 drives the motor 76 to move a Y table to thereby move the spindle 2 in Y direction (radial direction R) and the R·θ coordinates generator circuit 74 obtains a coordinates signal in the Y direction from the encoder 77 of the motor 76. The spindle motor drive circuit 73 drives the spindle motor 78 to rotate the spindle 2 on which the disk is mounted. The R·θ coordinates generator circuit 74 obtains a coordinates signal in 0 direction and an index signal as a rotation reference, from the encoder 79 of the spindle motor 78.

The control circuit 7 is controlled by the data processor 8 through the interface 71.

In the control circuit 7 constructed as mentioned above, when defect in the peripheral surface is to be detected, the Y table drive circuit 72 fixes the table in a position rs without driving the Y table and defect data of the disk for a full one revolution thereof is stored in the defect memory 63 according to the index signal.

This will be described in more detail below.

The R·θ coordinates generator circuit 74 enters into a peripheral surface defect detection mode according to the control signal from the data processor 8 through the interface 71. The R·θ coordinates generator circuit 74 drives the data sampling clock generator circuit 75 according to the index signal, which is a rotational reference position of the disk 1, from the encoder 79 to generate a sampling clock having a predetermined period. The thus generated sampling clock is supplied to the defect memory 63 to update its address periodically and bit data of the detection signals Da and Db are stored in the updated address position sequentially. The R·θ coordinates generator circuit 74 sends a inspection end signal to the interface 71 at a time when the inspection for one revolution of the disk is ended on the basis of the generation of the index signal and, simultaneously therewith, sends a stop signal to the data sampling clock generator circuit 75 to stop the generation of the sampling clock.

In response to the inspection end signal from the R·θ coordinates generator circuit 74, the interface 71 reads the defect data of the defect detection signals Da and/or Db from the defect memory 63 for each revolution of the disk and sends a first data position of the defect data from the defect detection signals Da an Db to the data processor 8 as the rotation reference of the disk 1.

The data processor 8 includes an MPU 81, a memory 82, a CRT display 83, a key board 84, etc., which are mutually connected through a bus 85. The memory 82 stores a defect classification program 82a, a defect size determination program 82b, a defect map display program 82c and a three-dimensional image data 82d of the disk 1, etc.

The defect classification program 82a is executed by the MPU 81. In response to the defect detection data for each revolution of the disk from the defect detection signals Da and Db, the MPU 81 classifies defects in the defect detection signal Da into defects in the chamfered portions ChU and ChD and defects in the defect detection signal Db into defects in the outer peripheral side surface. Further, according to the defect classification program 82a, the MPU 81 calculates the outer peripheral coordinates (θ coordinates) of the respective defect data positions correspondingly to the frequency of the sampling clock to thereby calculate positions of the defect data. Incidentally, the detecting resolution is determined by the sampling clock frequency, so that it is possible to set resolution to a high value.

Then, the MPU 81 executes the defect size determination program 82b to know continuities of the defect bits of the two kinds of data by referring to the defects classified into those in the chamfered portions and into those in the outer peripheral side surface to thereby determine the size thereof by grouping the defects according to the continuities. In this case, continuity between defect in the chamfered portions and defect in the outer peripheral side surface is also determined and, when there is continuity between them, these defects are decided as one defect. The size of defect may be classified into, for example, five groups. Thereafter, the MPU 81 executes the defect map display program 82c to produce a map by superimposing detection reference positions (positions at which the index signals are generated) on the three-dimensional image of the disk 1. On the three-dimensional image of the disk, the defects in the chamfered portions and the defect in the outer peripheral side surface are displayed by different colors and the grouped large defects are classified into five classes and displayed by symbols having five different sizes, respectively.

When defect in the chamfered portions and defect in the outer peripheral side surface form a single defect, the latter defect is displayed by putting one color for the former defect on another color for the latter defect.

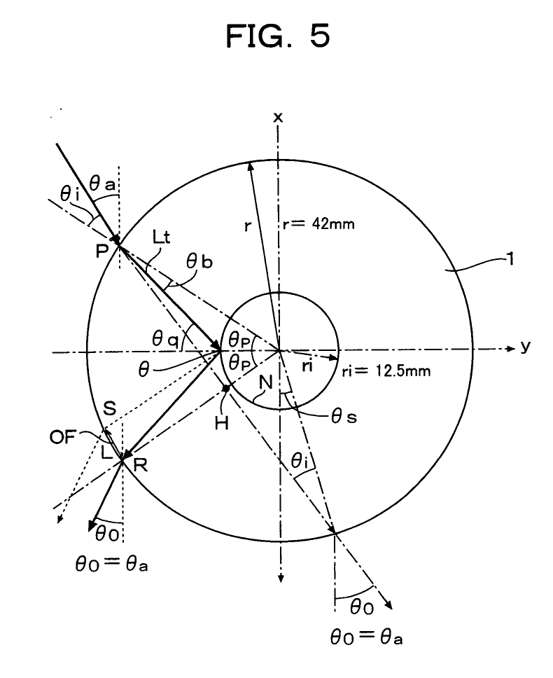

FIG. 5 is a plan view of a disk 1, showing another embodiment of the present invention, for detecting defects in the inner peripheral side surface thereof.

The incident angle θi of the laser spot Sp is 18.4° and the optical system is set such that laser beam Lt is refracted at the surface of the inspected region (the light receiving portion of the inner peripheral side surface of the disk) Q and enters into the disk at an angle of substantially 45°. Further, the incident angle θi of the laser beam is set such that, when the laser beam is not refracted at the incident point P and approaches the inner peripheral side surface N of the disk 1 as shown by a straight chain line, it crosses the radial line of the disk 1 at a position H, which is closest to the inner peripheral side surface N. By setting of the optical system as described, it is possible to irradiate the inspected region Q in the inner peripheral side surface with the incident laser beam incident at a large incident angle. Therefore, the reflectivity of the reflected light within the disk becomes large and scattered light is increased correspondingly thereto. Incidentally, if the straight light contacts with the inner peripheral side surface H, an amount of disturbing light is increased within the disk 1.

Determining the incident angle θi by calculating back such that the cross point of the radial line and the outer peripheral side surface of the disk 1 becomes the emitting position R of the reflected light as shown in FIG. 5, the optimal θi becomes 18.4°.

Therefore, the inspected region Q is set in the inside of the inner peripheral side surface of the disk 1 and irradiated with the laser spot Sp refracted at the incident point P.

Similarly to the case shown in FIG. 4, it is assumed that the disk 1 is a 3.3 inch disk having radius r=42 mm and refraction index n of the glass is 1.536. In such case, it becomes θa=38.7°, θp=12.1°, θs=20.3° and θq (the irradiating angle to the point Q)=45°.

Incidentally, the diameter ri of the center hole of the disk is 12.5 mm, coordinates of the point P is (22.783 (mm), −35.283 (mm)) and coordinates of the point H is (−8.298 (mm), −10.340 (mm)).

The first and second light receiving systems 4 and 5 are not shown in FIG. 5, for simplicity of illustration. Since the positional relation between the inspected region Q and the first light receiving system 4 and the positional relation between the second light receiving system and the detecting position S are similar to those shown in FIG. 1, detailed description thereof is omitted. The offset OF between the light emitting position R and the detecting position S is about 10 mm similarly to the embodiment shown in FIG. 1.

Defect in the inner peripheral side surface of the disk 1 can be detected with using the described settings of the optical system.

Incidentally, the incident angle θi is determined by the outer diameter r and the inner diameter ri of the disk 1 and the incident position P and is preferably in a range from 150 to 200 for the 3.3 inch disk.

The scattered light Lj and/or Lk received by the light receiving system 4 and/or 5 is compared in the defect detecting circuit with the threshold value Tha and/or Thb, which are set by the control circuit 7, classified on size by the data processor 8 and displayed as a map.

In the embodiment shown in FIG. 1, the light receiving position S is provided between the light emitting position R and the incident position P. However, the position S may be provided between the emitting position R and the inspected region Q. Similarly, in the embodiment shown in FIG. 5, the position S may be provided behind the emitting position R with respect to the incident position P.

Further, the optical fibers of the respective light receiving systems may be substituted by light receiving elements such as image sensors.

Further, although the laser beam is used to irradiate the inspected region, general light beams may be used instead of the laser beams.

Although the disk formed of glass is described, a magnetic disk including a glass substrate, a magnetic layer formed thereon and a protective layer formed on the magnetic layer can be inspected according to the present invention since such magnetic disk is translucent or transparent. Further, the present invention can be applied to a inspection of the glass disk or the transmission disk on defect in an inner and outer peripheral edge portions.

Incidentally, it should be noted that the term “defect” used in this specification means not only crack, scratch, flaw, etc., but also general damage of the glass disk.

1. An optical system for detecting defect in a edge portion of a disk which is translucent or transparent, comprising:
a illumination system for illuminating light beam to a inspected region of said edge portion of said disk through an inside portion of said disk by directing the light beam at a predetermined incident angle with respect to a peripheral surface of said disk to be inspected; and
a first light receiving system provided externally of said disk in a vicinity of said inspected region, for receiving scattered light from said inspected region.

2. The optical system for detecting defect as claimed in claim 1, wherein said light beam is made a spot, said spot is incident in an outer peripheral surface and said first light receiving system receives scattered light from said inspected region of said disk, which is rotating.

3. The optical system for detecting defect as claimed in claim 2, wherein said disk is a glass disk and said spot is incident in an outer peripheral side surface of said outer peripheral surface.

4. The optical system for detecting defect as claimed in claim 3, further comprising a second light receiving system provided externally of said disk, for receiving scattered light propagating within said disk from said inspected region thereof and emitted externally of said disk from a position or in the vicinity thereof, which is offset by a predetermined distance from a position of said outer peripheral side surface symmetrical to said incident position of said spot in said outer peripheral side surface about a diameter line of said disk passing through said inspected region.

5. The optical system for detecting defect as claimed in claim 4, wherein said light beam spot is a laser light, each of said first and second light receiving systems has a light receiving plane, said light receiving plane is set at a certain angle within a range from 20° to 60° with respect to an upper or lower surfaces of said disk.

6. The optical system for detecting defect as claimed in claim 5, wherein said light receiving plane of said first light receiving system is opposing to a chamfered surface on said lower surface side of said disk, for detecting defect in said chamfered surface, and said light receiving plane of said second light receiving system is substantially vertical to said chamfered surface, for detecting defect in said inner peripheral side surface or said outer peripheral side surface.

7. The optical system for detecting defect as claimed in claim 4, wherein said light beam spot is a laser light, each of said first and second light receiving systems is a light receiver including an optical fiber and a light receiving plane of said optical fiber is set at a certain angle within a range from 20° to 60° with respect to an upper or lower surfaces of said disk.

8. The optical system for detecting defect as claimed in claim 7, wherein said light receiving plane of said optical fiber of said first light receiving system is opposing to a chamfered surface on said lower surface side of said disk, for detecting defect in said chamfered surface, and said light receiving plane of said optical fiber of said second light receiving system is substantially vertical to said chamfered surface, for detecting defect in said inner peripheral side surface or said outer peripheral side surface.

9. A peripheral defect detector for detecting defect in a edge portion of a disk which is translucent or transparent, comprising:
a illumination system for illuminating light beam to a inspected region of said edge portion of said disk through an inside portion of said disk by directing the light beam at a predetermined incident angle with respect to a peripheral surface of said disk to be inspected;
a first light receiving system provided externally of said disk in a vicinity of said inspected region, for receiving scattered light from said inspected region.
a drive mechanism for rotating a spindle on which said disk is mounted; and
a detection circuit for detecting defect in said inspected region of said disk by obtaining detection signal from said first light receiving system while rotating said disk.

10. The peripheral defect detector as claimed in claim 9, wherein said light beam is made a spot, said spot is incident in an outer peripheral surface.

11. The peripheral defect detector as claimed in claim 10, wherein said disk is a glass disk and said spot is incident in an outer peripheral side surface of said outer peripheral surface.

12. The peripheral defect detector as claimed in claim 11, further comprising a second light receiving system provided externally of said disk, for receiving scattered light propagating within said disk from said inspected region thereof and emitted externally of said disk from a position or in the vicinity thereof, which is offset by a predetermined distance from a position of said outer peripheral side surface symmetrical to said incident position of said spot in said outer peripheral side surface about a diameter line of said disk passing through said inspected region.

13. The peripheral defect detector as claimed in claim 12, wherein said light beam spot is a laser light, each of said first and second light receiving systems has a light receiving plane, said light receiving plane is set at a certain angle within a range from 20° to 60° with respect to an upper or lower surfaces of said disk.

14. The peripheral defect detector as claimed in claim 13, wherein said light receiving plane of said first light receiving system is opposing to a chamfered surface on said lower surface side of said disk, for detecting defect in said chamfered surface, and said light receiving plane of said second light receiving system is substantially vertical to said chamfered surface, for detecting defect in said inner peripheral side surface or said outer peripheral side surface.

15. The peripheral defect detector as claimed in claim 12, wherein said light beam spot is a laser light, each of said first and second light receiving systems is a light receiver including an optical fiber and a light receiving plane of said optical fiber is set at a certain angle within a range from 20° to 60° with respect to an upper or lower surfaces of said disk.

16. A peripheral surface defect detection method for detecting defect in a edge portion of a disk which is translucent or transparent, comprising the steps of:
illuminating light beam to a inspected region of said edge portion of said disk through an inside portion of said disk by directing the light beam at a predetermined incident angle with respect to a peripheral surface of said disk to be inspected; and
receiving scattered light from said inspected region by a first light receiving system provided externally of said disk in the vicinity of said inspected region while rotating said disk.

17. The peripheral surface defect detection method as claimed in claim 16, wherein said light beam is made a spot, said disk is a glass disk and said peripheral surface is an outer peripheral surface and said disk is mounted on a spindle and rotated.

18. The peripheral surface defect detection method as claimed in claim 17, wherein said disk is a glass disk and said spot is incident in an outer peripheral side surface of said outer peripheral surface.

19. The peripheral surface defect detection method as claimed in claim 18, further comprising the step of receiving, by a second light receiving system provided externally of said disk, scattered light propagating within said disk from said inspected region thereof and emitted externally of said disk from a position or in the vicinity thereof, which is offset by a predetermined distance from a position of said outer peripheral side surface symmetrical to said incident position of said spot in said outer peripheral side surface about a diameter line of said disk passing through said inspected region.

20. The peripheral surface defect detection method as claimed in claim 19, wherein said light beam spot is a laser light, each of said first and second light receiving systems has a light receiving plane, said light receiving plane is set at a certain angle within a range from 20° to 60° with respect to an upper or lower surfaces of said disk.
